(19) United States
(12) Patent Application Publication
(10) Pub. No.: US 2026/0105757 A1
(43) Pub. Date: Apr. 16, 2026

(54) VISUAL LANGUAGE MODEL INSTRUCTION TUNING FOR ENHANCED SPATIAL REASONING

(71) Applicant: NEC Laboratories America, Inc., Princeton, NJ (US)

(72) Inventors: Yumin Suh, Santa Clara, CA (US); Vijay Kumar Baikampady Gopalkrishna, San Jose, CA (US); Samuel Schulter, Long Island City, NY (US); Masoud Faraki, Redwood City, CA (US); Manmohan Chandraker, Santa Clara, CA (US); Dohwan Ko, San Jose, CA (US)

(21) Appl. No.: 19/354,161

(22) Filed: Oct. 9, 2025

Related U.S. Application Data
(60) Provisional application No. 63/706,213, filed on Oct. 11, 2024.
(60) Provisional application No. 63/719,708, filed on Nov. 13, 2024.

(51) Int. Cl. G06V 20/58; G06T 7/12; G06T 7/20; G06T 7/70; G06V 10/25; G06V 20/56

(52) U.S. Cl. CPC G06V 20/58; G06T 7/12; G06T 7/20; G06T 7/70; G06V 10/25; G06V 20/588; G06T 2207/30241

(57) ABSTRACT

Systems and methods for generating training data. More specifically, extracting bounding boxes and quaternion data of objects in selected image frames, the quaternion data representing a spatial orientation of the objects, determining coordinates of the bounding boxes and the quaternion data for the objects in the selected image frames, and evaluating kinematic quantities of the objects with monotonic timestamps of the selected image frames, the evaluation including scaling the objects using depth data from three dimensional (3D) imaging. The systems and methods further include correlating the kinematic quantities to natural language text, form instruction-following training data for spatial reasoning based on the correlated kinematic quantities and natural language text, the spatial reasoning including performing tasks that include spatio-temporal dynamics, training a visual language model with the instruction-following training data, and predicting the kinematic quantities of environmental objects in live video feeds from an autonomous vehicle.

### RELATED APPLICATION INFORMATION

This application claims priority to U.S. Provisional Patent No. 63/706,213, filed on Oct. 11, 2024, and U.S. Provisional Patent No. 63/719,708, filed on Nov. 13, 2024, incorporated herein by reference in their entirety.

### BACKGROUND

### Technical Field

The present invention relates to training data generation and artificial intelligence model training and more particularly for generating training data for spatio-temporal dynamics for improved Visual Language Model training.

### Description of the Related Art

Vision (or Visual)-Language Models (VLMs) can work with visual and textual information to generate inferences. VLMs can process both visual and textual information. Often, the visual aspect of VLMs are trained on still (e.g., static, non-moving) images. However, only training VLMs on still images has flaws. Using a single image for training of VLMs involves annotating extensive images with three dimensional (3D) spatial information, such as the depth of an object and the size of the object, but fails to improve the ability of the VLM to generate videos which incorporate a temporal aspect. In other words, VLMs trained solely on spatial reasoning datasets perform poorly on tasks that use a temporal understanding since they are limited to analyzing static spatial relationships and cannot process temporal dynamics like motion and kinematics. This inability to consider kinematics limits the VLM's utility when tasked with processing a video since the VLM cannot predict object motion.

### SUMMARY

According to an aspect of the present invention, a method is provided for generating training data. The method includes extracting bounding boxes and quaternion data of objects in selected image frames, the quaternion data representing a spatial orientation of the objects, determining coordinates of the bounding boxes and the quaternion data for the objects in the selected image frames, evaluating kinematic quantities of the objects with monotonic timestamps of the selected image frames, the evaluating including scaling the objects using depth data from three dimensional (3D) imaging, and correlating the kinematic quantities to natural language text. The method further includes forming instruction-following training data for spatial reasoning based on the correlated kinematic quantities and natural language text, the spatial reasoning including performing tasks that include spatio-temporal dynamics and training a visual language model with the instruction-following training data.

According to another aspect of the present invention, a system is provided for a processor and a memory storing computer-readable instructions. The memory causes the processor to extract bounding boxes and quaternion data of objects in selected image frames, the quaternion data representing a spatial orientation of the objects, determine coordinates of the bounding boxes and the quaternion data for the objects in the selected image frames, and evaluate kinematic quantities of the objects with monotonic timestamps of the selected image frames, the evaluation including scaling the objects using depth data from three dimensional (3D) imaging. The memory further causes the processor to correlate the kinematic quantities to natural language text, form instruction-following training data for spatial reasoning based on the correlated kinematic quantities and natural language text, the spatial reasoning including performing tasks that include spatio-temporal dynamics, train a visual language model with the instruction-following training data, and predict the kinematic quantities of environmental objects in live video feeds from an autonomous vehicle.

According to yet another aspect of the present invention, a computer program product comprising a non-transitory computer-readable storage medium containing computer program code, the computer program code when executed by one or more processors causes the one or more processors to perform operations. The operations including, causing the processors to extract bounding boxes and quaternion data of objects in selected image frames, the quaternion data representing a spatial orientation of the objects, determine coordinates of the bounding boxes and the quaternion data for the objects in the selected image frames, evaluate kinematic quantities of the objects with monotonic timestamps of the selected image frames, the evaluation including scaling the objects using depth data from three dimensional (3D) imaging, and correlate the kinematic quantities to natural language text. The operations further cause the processors to form instruction-following training data for spatial reasoning based on the correlated kinematic quantities and natural language text, the spatial reasoning including performing tasks that include spatio-temporal dynamics, train a visual language model with the instruction-following training data, and predict the kinematic quantities of environmental objects in live video feeds from an autonomous vehicle.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a computer environment for visual language model instruction tuning for enhanced spatial reasoning, in accordance with an embodiment of the present invention;

FIG. 2 is a flow diagram illustrating a method of forming instruction-following data for spatial reasoning, in accordance with an embodiments of the present invention

FIG. 3 are several block diagrams illustrating a system for generating pseudo ground truth pairs for training a visual language model on spatio-temporal reasoning, in accordance with an embodiments of the present invention;

FIG. 4 is a schematic diagram illustrating a system for forming spatio-temporal training data for a visual language model, in accordance with an embodiments of the present invention;

FIG. 5 is a table illustrating tasks that can be performed using spatio-temporal reasoning, in accordance with an embodiment of the present invention;

FIG. 6 is a schematic diagram illustrating a system for training spatio-temporal reasoning for an autonomous vehicle, in accordance with an embodiment of the present invention;

FIGS. 7 and 8 are a flow diagram illustrating a method of forming training data for spatio-temporal reasoning, in accordance with an embodiments of the present invention; and

FIG. 9 is a block diagram illustrating an artificial neural network employed, in accordance with an embodiment of the present invention.

### DETAILED DESCRIPTION OF PREFERRED EMBODIMENTS

Spatio-temporal reasoning is the ability to infer spatial and temporal relationships within dynamic environments. Spatio-temporal reasoning can be useful in understanding the physical world, with applications in autonomous driving, robotics, and sports analytics, among others. In autonomous driving, spatio-temporal reasoning can enhance a model's ability to predict the speed and the direction of other vehicles on the road. This can improve decision making capabilities by more accurately understanding when collisions are possible or impending. In robotics, spatio-temporal reasoning can enhance navigation and trajectory predictions. This can produce more efficient robot navigation routes by better understanding the space around robots and incorporate moving components into the trajectory. In sports analytics, spatio-temporal reasoning can model kinematic quantities of objects (e.g., cars, people, balls, pucks).

Spatio-temporal reasoning can be useful in situations when objects interact with the environment and each other and/or objects act differently over time. Knowing both where and when objects are moving to and from, through the use of spatio-temporal reasoning can improve the ability of a model to predict and generate future object interactions. Spatio-temporal reasoning can be particularly useful in Visual Language Models (VLMs) which can have tasks that apply temporal aspects to vision-based tasks.

In accordance with an embodiment of the present invention, a spatio-temporal reasoning training dataset can be formed to reflect and evaluate dynamic elements involving motion and kinematics for more robust VLM inference. The spatio-temporal reasoning training dataset can include real-world videos with ground truth annotations from Light Detection and Ranging (LiDAR) data. The ground truth annotations can describe object motion dynamics such as distance traveled, speed, direction moved, inter-object distance comparisons, and direction of relative motion.

Other types of imaging data are also contemplated such as Radio Detection and Ranging (RADAR), Ultrasound/Sound Navigation and Ranging (SONAR), Stereo Vision (e.g., cameras with depth sensing), Time of Flight cameras, Structure Light Systems, Event-based Cameras, Wi-Fi®, Bluetooth®, Near Field Communication (NFC®), and Ultra-Wideband (UWB), etc. These technologies and others allow for three-dimensional (3D) sensing capabilities which aid in scaling, depth perception, and other aspects of spatio-temporal training data generation.

To scale the data to videos without (or with limited) LiDAR, an automatic pipeline that generates pseudo-labels using four-dimensional (4D) reconstructions in a metric space can be implemented. LiDAR provides 3D geometric information about the scene, such as object depth, size, and spatial layout, which can be useful for tasks that require metric-scale understanding and can be tracked over time to provide a fourth dimension that is temporal. LiDAR and other 3D sensing capabilities can be monetarily expensive and computationally intensive, so limiting the amount of 3D sensing collected can improve the training time and amount of processing power and memory used in VLM training. Additionally limiting LiDAR use can reduce computational complexity by reducing filtering, down sampling, classifying, etc., thereby forming lighter-weight models (and consequently reducing latency, etc.).

An embodiment of the present invention can train a VLM for spatio-temporal tasks with instruction-following training data, thereby enhancing the utility of the VLM. For example, the VLM can be trained with multimodal instruction-following datasets that include paired video clips and textual descriptions that capture temporal events, actions, or motion sequences. Such training enables the VLM to understand and generate outputs that reflect both spatial and temporal relationships, thereby improving the performance of the VLM on video-related or spatiotemporal-dependent tasks. With spatio-temporal capability, artificial intelligence models can better understand kinematic quantities and consequently, the physical world.

An embodiment of the present invention can develop training data for autonomous vehicles (AV) with spatio-temporal reasoning. For example, a VLM with spatio-temporal reasoning capabilities can be used to analyze a video of two cars driving on a road and predict which car is moving faster, estimate the exact direction and exact speed of a specific vehicle, and/or the exact trajectory of one or both of the vehicles. These determinations can help the VLM decide which action to perform or if an action is even necessary. These are capabilities humans find impossible or practically impossible to perform in some circumstances, such as evaluating in real-time, or evaluating within degree of certainty. The actions can include using lighting systems, navigation systems, steering, acceleration and braking systems, etc.

Embodiments of the present invention generate an instruction-following training dataset based on LiDAR annotations from videos. The instruction-following dataset can include instructions for the VLM to follow based on an image with known ground truth values for the instructions. The LiDAR based annotations can then be used in other circumstances, thereby minimizing the LiDAR usage. The instruction-following dataset can focus on dynamic scenes where at least some object movement occurs. By leveraging 3D coordinates obtained at images with a given timestamp (e.g., an image with a timestamp 0.5 seconds later than a previous image), a detailed set of question-answer (QA) pairs for the instruction-following training dataset can be generated. The QA pairs encompass various spatio-temporal reasoning tasks involving motion and kinematics.

In some instances, acquiring high-quality 3D coordinates for moving objects throughout videos involves LiDAR data which is resource intensive. To avoid entirely LiDAR acquired data, a pseudo-labeling pipeline that utilizes a 4D reconstruction module to estimate 3D coordinates from videos without (or with minimal) LiDAR annotations can be employed. The training data can include both LiDAR-based and pseudo-labeled video samples. The LiDAR-based data provides accurate 3D spatial ground truth for supervision, while the pseudo-labeled data extends the dataset to cover a range of scenes and motions. By training VLMs on both high-quality LiDAR-based data and pseudo-labeled data, the VLM can understand both spatial information and temporal dynamics. Incorporating pseudo-labeled data can increase the training data volume and further enhance the VLM's spatio-temporal understanding by augmenting data for a more robust training of the model.

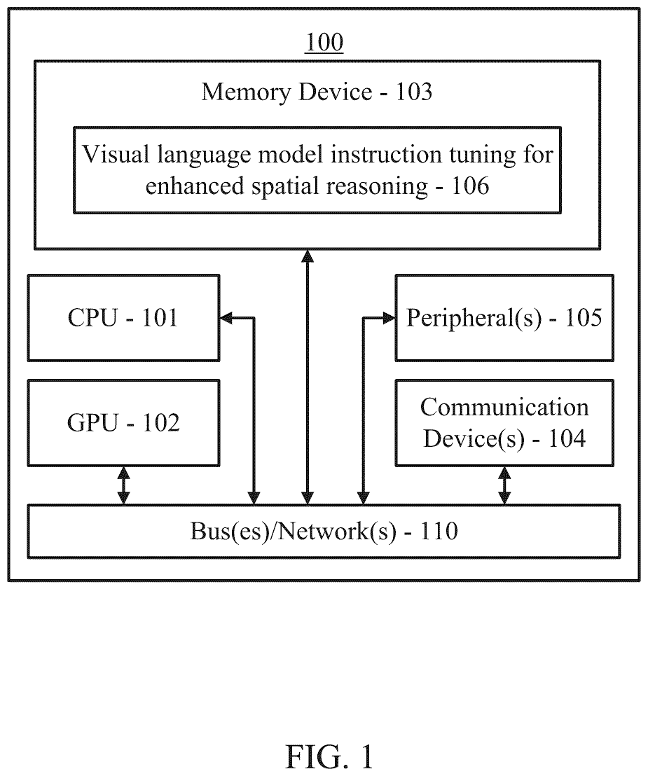

Referring now in detail to the figures in which like numerals represent the same or similar elements, and initially to FIG. 1, a block diagram is shown for an exemplary processing system 100, in accordance with an embodiment of the present invention. Processing system 100 can generate training data for a VLM that incorporates spatio-temporal reasoning. Additionally, or alternatively, processing system 100 can train the VLM on spatio-temporal reasoning data (e.g., instruction-following data). Processing system 100 includes a set of processing units (e.g., CPUs) 101, a set of GPUs 102, a set of memory devices 103, a set of communication devices 104, and a set of peripherals 105. CPUs 101 can be single or multi-core CPUs. The GPUs 102 can be single or multi-core GPUs. The one or more memory devices 103 can include caches, RAMs, ROMs, and other memories (flash, optical, magnetic, etc.). The communication devices 104 can include wireless and/or wired communication devices (e.g., network (e.g., Wi-Fi®, etc.) adapters, etc.). The peripherals 105 can include a display device, a user input device, a printer, an imaging device, and so forth. Elements of processing system 100 are connected by one or more buses or networks (collectively denoted by the figure reference numeral 110).

In an embodiment of the present invention, memory devices 103 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 103 store program code or software 106 for visual language model instruction tuning for enhanced spatial reasoning. The generation and execution software 106 includes extracting bounding boxes and quaternion data of objects in selected image frames, the quaternion data representing a spatial orientation of the objects, determining coordinates of the bounding boxes and the quaternion data for the objects in the selected image frames, evaluating kinematic quantities of the objects with monotonic timestamps of the selected image frames, the evaluation including scaling the objects using depth data from three dimensional (3D) imaging. Software 106 also includes correlating the kinematic quantities to natural language text, forming instruction-following training data for spatial reasoning based on the correlated kinematic quantities and natural language text, the spatial reasoning including performing tasks that include spatio-temporal dynamics, training a visual language model with the instruction-following training data; and predicting the kinematic quantities of environmental objects in live video feeds from an autonomous vehicle.

Of course, the processing system 100 may also include other elements (not shown), as readily contemplated by one of skill in the art, as well as omitting certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 100 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 100.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

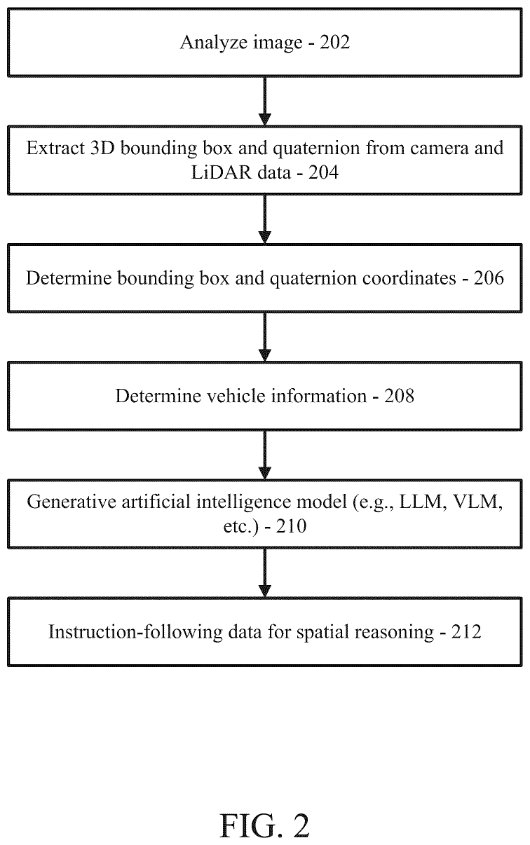

Referring to FIG. 2, a flow diagram of a method for generating instruction tuning (following) training data for enhanced spatial reasoning is illustrated. In block 202, images are analyzed. The images can be still shots taken alone or from a video. Analyzing the image can include analyzing metadata of the image such as timestamps and Global Positioning System (GPS) data from when the image was taken or the video was filmed which can add context to the image. The added context can aid the VLM in understanding spatio-temporal aspects of the image. For example, in an image of a pier, knowing the location and time difference of the image can allow the VLM to determine tide changes. From the tide changes sea level changes of the pier can aid in determining scale and orientation of the image.

The images can also be generated using data augmentation techniques. The image can be cropped to remove confusing or unnecessary context or otherwise modified in preparation of processing the image. In block 204, 3D bounding boxes are extracted from objects in the images and quaternion data is extracted from camera and LiDAR data. The bounding box can be described as either a corner format or center format.

In block 206, the extracted bounding boxes and quaternions are analyzed to determine their coordinates and descriptive notations. 3D bounding box coordinates can include [x, y, z, l, w, h] information (3 dimensions, 3 distances) and quaternion information can include [qw, qx, qy, qz] information (e.g., one scalar for the angle of rotation, one three-dimensional vector for the unit vector). This data can be analyzed to determine trajectories. In an embodiment of the present invention of the present invention tracking the quaternion data of an object over several images can indicate the trajectory of the object relative to the image capturing device and the location of the object can be defined by the bounding box.

In block 208, vehicle information is can include the distance of a vehicle from an ego car (the car that an autonomous vehicle system is for), vehicle orientation, and vehicles lane. In other words, the bounding box and quaternion data can be processed to determine the location of the object in the physical world relative the image capture device and other aspects of the object. Quaternion data can include notation for representing spatial orientations and rotations of elements in three dimensional space. These other aspects can include location, scale (e.g., size), trajectory, velocity and other kinematic quantities, and orientation.

In block 210, the vehicle information is fed into a generative artificial intelligence model (GenAI) like a Large Language Model (LLM) or VLM. The Gen AI model can use the vehicle information and the images to understand spatio-temporal reasoning. In some embodiments of the present invention the information can be input into a VLM. The visual information can then be transformed into textual or numerical features, such as coordinate data or structured scene descriptions, which can then be input to an LLM for reasoning.

In block 212, the GenAI model generates instruction-following data for spatial reasoning. The instruction-following data can include prompts such as “This image shows the view captured from the front side of the ego car. Give a rundown of the area within 30 meters in front of the ego car, including information on any vehicles found there. Specify each vehicle's lane, orientation, and distance from the ego car.” The VLM can generate a correct output such as “1 vehicle is on the front side of the ego car within 30 meters. A truck is positioned in the same lane, 19 meters ahead of the ego car, and it's facing the 8 o'clock direction.” In other words, the VLM can perform tasks like visual question answering (VQA) based on the training/training data. VQA can include identifying objects within a radius of a given datum object and the directions of each object is facing, among other responses. This can provide promote, enable, and/or facilitate better scene analysis in images or videos during the inference phase of the AI model which can consequently make the model better suited for autonomous driving and other uses.

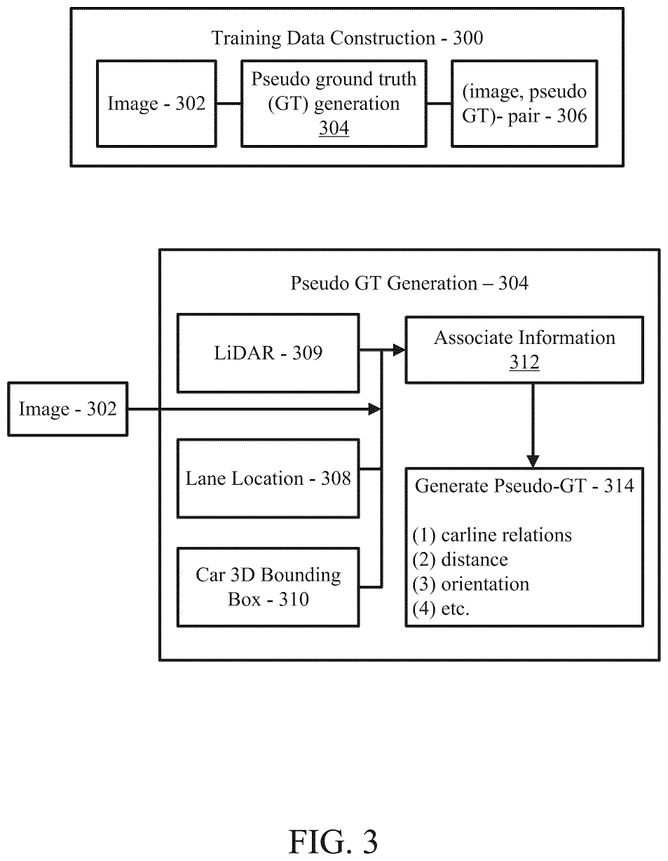

Referring to FIG. 3, a system for constructing training data for spatio-temporal reasoning is illustrated. Training data construction 300 can include receiving an image 302, generating pseudo ground truths 304, and forming pairs of image and pseudo ground truth 306. The image can be timestamped portions of a video. Image 302 can be an individual frame of a video.

Pseudo ground truth generation 304 can include LiDAR 309, lane location 308, and car 3D bounding box 310. LiDAR 309 can include LiDAR measurements, though other technologies like RADAR, SONAR, etc., are also contemplated. Lane location 308 can apply computer vision or other techniques to identify driving lanes on a vehicle passageway (e.g., highway, street, etc.).

Car 3D bounding box 310 can include determining the coordinates of the outer edges of a vehicle (or other object) and determining the center based on the shape. Lane location 308 and car 3D bounding box 310 can be derived from image 302. From LiDAR 309, lane location 308, and 3D bounding box 310, the information can be combined along with image 302 to form associate information 312. Associate information 312 is an aggregation of the information and corresponding images 302 to form video-level information. From associate information 312, pseudo ground truth 314 can be formed. Pseudo ground truth 314 includes carline relations, distance, orientation, and other information. Pseudo ground truth 314 is a video-text pair that includes multiple frames that collectively capture temporal dynamics from associate information 312.

A VLM which can receive various forms of visual inputs, e.g., multi-images or a video. The input is fine-tuned with both generated 4D reconstruction-based pseudo-labeled ground truth 314 and LiDAR-based high-quality spatio-temporal reasoning data.

Fine-tuning with only spatio-temporal reasoning data can degrade the performance on other aspects of the AI model. To put this another way, the VLM can become overfitted to spatio-temporal tasks and have worse performance at spatio-static tasks (e.g., catastrophic forgetting). To avoid this, the spatio-temporal reasoning dataset can be blended with a subset of general supervised finetuning (SFT) datasets.

The spatio-temporal dataset can be mixed with a portion of general instruction-following, video understanding, and image understanding SFT data to preserve the overall performance of the AI model on both static spatial reasoning and general visual understanding tasks while enhancing its spatio-temporal reasoning ability.

With distance and direction information determined in generating pseudo ground truths 304, a template-based approach to construct question answer (QA) pairs can be used for the instruction-following dataset. Furthermore, to provide an object location for the model in each image, car 3D bounding box 310 is overlaid on each frame. Then, the generated QA pair and the video with car 3D bounding boxes 310 are fed into the model for training.

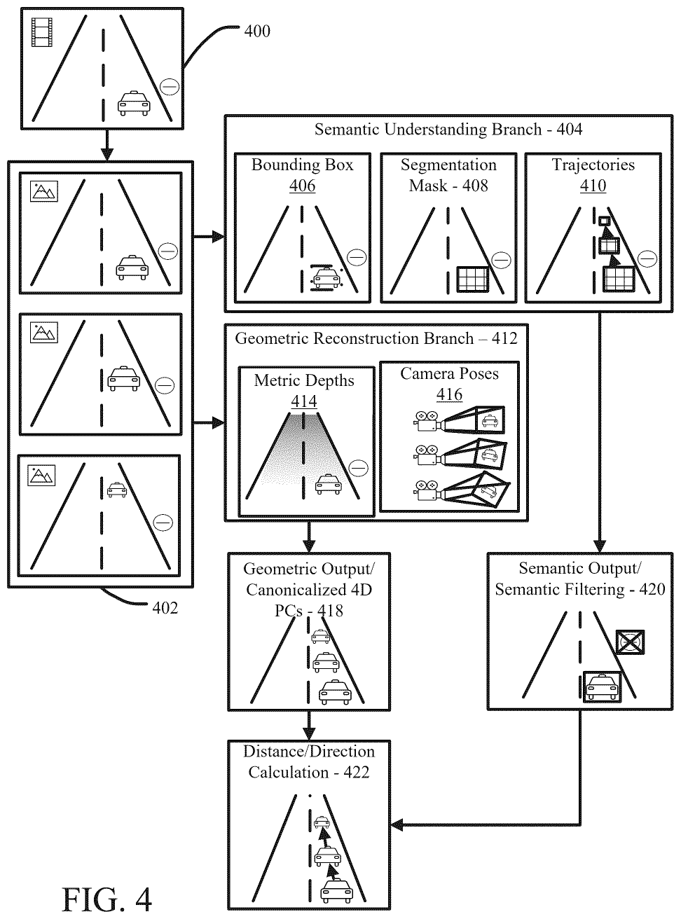

Referring to FIG. 4, a schematic diagram is shown that illustrates how distance and direction tasks are calculated in embodiments of the present invention. A pseudo-labeling pipeline based on 4D reconstruction is implemented to extend the approach to videos without LiDAR annotations, since many videos lack LiDAR annotations due to the expense of sensing equipment and other limitations. LiDAR can be used in some embodiments of the present invention to provide supervision, particularly where LiDAR annotations are already available in public datasets but is not necessary if LiDAR is not available. By leveraging such existing LiDAR data, the pseudo-labeling pipeline can be extended to generate labels for videos without LiDAR, thereby enabling broader scalability.

4D scenes are reconstructed from unlabeled video 400. Different images 402 are parsed from unlabeled video 400 reflecting different timestamps which lift segmented objects from two dimensional (2D) frames into 3D point cloud space with limited or no need for LiDAR or camera poses. The temporal, fourth dimension can be exhibited from changed between different images 402. This 4D reconstruction allows for spatio-temporal grounding outlined to a broader range of videos. The 4D reconstruction enables embodiments of the present invention to predict kinematic quantities for each object.

For the 4D reconstruction from unlabeled video 400, third party solutions can be implemented into embodiments of the present invention such as, e.g., Monst3r™, which proposes a 4D reconstruction framework that estimates scene geometry including depth and camera intrinsic/extrinsic, even in dynamic videos containing moving objects. However, the reconstructed space by Monst3r™ is not aligned with the real-world scale, since it lacks a fixed reference for depth, resulting in reconstructions that are accurate in shape but arbitrary in size. This can lead to problems with spatio-temporal reasoning tasks since the tasks implement measurements of dynamic properties.

To address the scale ambiguity, other third-party solutions such as e.g., Metric3Dv2™, can be integrated to obtain the absolute metric depth 414 at the real-world scale. Metric depth 414 illustrates objects at different depths in different images 402 to help determine the depth of each object. Camera poses 416 view the different positions and orientations that the camera is at. Camera poses 416 can also correspond to extrinsic parameters (e.g., the camera's position and orientation in the world coordinate system) and can involve intrinsic calibration parameters. The reconstructed 4D scene can be canonicalized by rescaling the original depth estimates from Monst3r™ to metric depth 414 from Metric3Dv2™ and camera pose 416 using geometric output and canonicalized 4D 418.

Bounding boxes 406, segmentation masks 408, and trajectories 410 (e.g., trajectory) of selected objects are extracted based on the open-vocabulary video semantic understanding model. Bounding box 406 can capture the objects of interest in images 402. Segmentation mask 408 can cover bounding box 406 area to further identify the object. From the kinematic quantities, and other information trajectories 410 can determine the future kinematic quantities of the object(s).

To ensure the reliability of pseudo-labels, detected objects can be filtered based on confidence scores and bounding box 406 sizes using semantic output and semantic filtering 420. For instance, in different images 402 there can be a sign on the side of the road that is of no or little importance. The sign can be identified in semantic understanding branch 404 but filtered out in filtering 420 since bounding box 406 for the sign is not necessary for spatio-temporal tasks.

By integrating the outputs from the geometric reconstruction branch 412 and the semantic understanding branch 404, the 2D segmentation mask of the selected objects is lifted into a 3D point cloud within the canonicalized 4D reconstructed scene. The distance traveled, speed, and moving direction for each object in the 3D space are calculated by tracking the barycenter of 3D object coordinates across video frames. To address inaccurate reconstruction results, filtering and smoothing strategies are also developed for estimating barycenter trajectories. With the geometric output/canonicalized 4D 418 and semantic output/semantic filtering 420 distance/direction calculation 422 can be computed. Distance/direction calculation 422 can be used to create pseudo-labeled training data for VLM finetuning, allowing the AI model to learn motion-related reasoning such as distance traveled and direction of movement.

Filtering can include excluding bounding boxes less than a predetermined size, exclude detections with a box or text confidence below a predetermined value, exclude trajectories with a cosine similarity outside a predetermined range of a mean direction vector. Smoothing can include 3D Kalman filtering. Other filtering techniques are also contemplated.

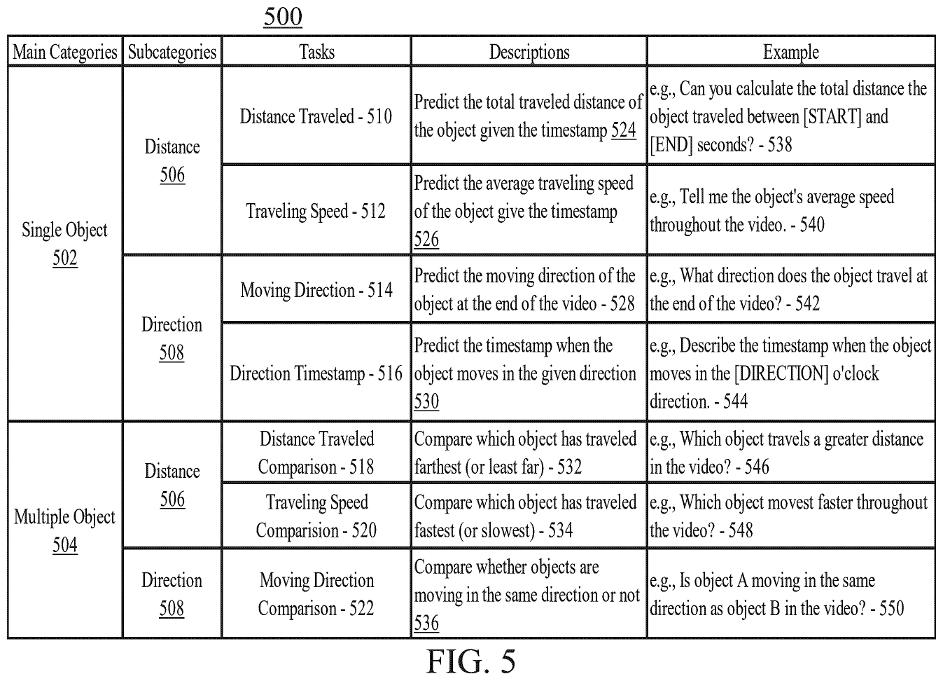

Referring to FIG. 5, a table of different tasks a spatio-temporally trained VLM can perform is shown. Spatio-temporal reasoning instructions can cover several tasks designed to enhance the reasoning capabilities of VLMs from various perspectives. In one embodiment of the present invention, there are seven tasks, though other tasks are also contemplated. The tasks can act as benchmarks for assessing VLM spatio-temporal reasoning ability, e.g., distance traveled, traveling speed, and moving direction, a benchmark can be developed. For evaluation of the benchmark, third-party implementations can be used to extract the prediction from the response in natural language. Then, the prediction and the ground-truth answer are compared, and the performance can be measured by adopting the following metrics:

Given the ground-truth answer y and the prediction ŷ the bench mark for several tasks can be defined as,
(1) Distance Traveled and (2) Traveling Speed: Accuracy (correct if y×0.75≤ŷ≤1.25) and a mean absolute error of (MAE) (|y−ŷ|).
(3) Moving Direction: Accuracy (correct if y=ŷ in the clockwise direction) and MAE (|y−ŷ| in the clockwise direction).
(4) Direction Timestamp: Accuracy (correct if IoU (y, ŷ)≥0.5) and IoU.
(5) Distance Traveled Comparison, (6) Traveling Speed Comparison, and (7) Moving Direction Comparison: Accuracy (binary classification).

These benchmarks can evaluate the success for completing a given task such as the preciseness (correctness) to the correct value and mean absolute error (MAE). For example, MAE can describe the average discrepancy between the ground truth and predicted answer.

An AI model trained using training data derived from embodiments of the present invention blended with other training data has been shown to have improved capabilities of these tasks compared to AI models without this training. The AI model with the augmented data that has the training data blended with other types of training data perform spatio-temporal tasks without catastrophic forgetting (forgetting previously learned information when trained on new information).

Table 500 illustrates one manner of visualizing the tasks. These tasks can be grouped into two categories: single object 502 and multiple object 504. The categories can be subdivided into two subcategories: distance 506 and direction 508. The spatio-temporal reasoning tasks for single objects 502 are distance traveled 510, traveling speed 512, moving direction 514, and direction timestamp 516. The spatio-temporal reasoning tasks for multiple object 504 are distance traveled comparison 518, traveling speed comparison 520, and moving direction comparison 522.

Distance traveled 510 can relate to predicting the total distance traveled of the object given the timestamps 524. Traveling speed 512 can relate to predicting the average travel speed of the object given the timestamps 526. Moving direction 514 can relate to predicting the moving direction of the object at the end of video 528. Direction timestamp 516 can relate to predicting the timestamp when the object moves in the given direction 530.

Distance traveled comparison 518 can relate to comparing which object has traveled the farthest (or least) 532. Traveling speed comparison 520 can relate to comparing which object has traveled fastest (or slowest) 534. Moving direction comparison 522 can relate to comparing whether objects are moving the same direction or not 536.

The tasks enable the model to understand both the absolute distance and direction of an object's movement, as well as the relative distance and direction by comparing multiple objects. To successfully manage these tasks, the VLM infers spatial information (e.g., object localization) and temporal information (e.g., object tracking), enabling the development of complex spatio-temporal reasoning abilities that build upon the prior knowledge of LLMs. This refers to the VLM utilizing the prior linguistic and reasoning knowledge of LLMs as a foundation and extending this knowledge to incorporate spatial and temporal reasoning based on visual inputs.

Example prompt 538 (“Can you calculate the total distance the object traveled between [START] and [END] seconds?”) can relate to distance traveled 510. Example prompt 540 (“Tell me the object's average speed throughout the video.”) can relate to traveling speed 512. Example prompt 542 (“What direction does the object travel at the end of the video?”) can relate to moving direction 514. Example prompt 544 (“Describe the timestamp when the object moves in the [DIRECTION] o'clock direction.”) can relate to direction timestamp 516. Example prompt 546 (“Which object travels a greater distance in the video?”) can relate to distance traveled comparison 518. Example prompt 548 (“Which object moves faster throughout the video?”) can relate to traveling speed comparison 520. Example prompt 550 (“Is object A moving in the same direction as object B in the video?”) can relate to moving direction comparison 522.

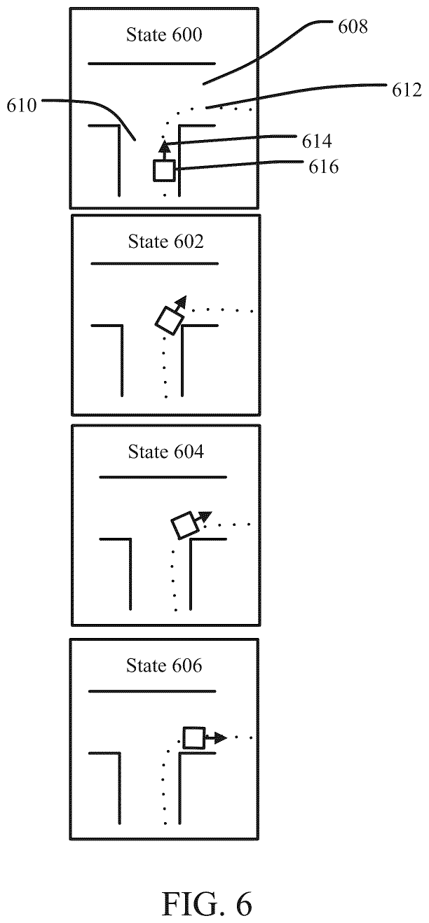

Referring to FIG. 6, a series of schematic diagrams representing a progression of top-view images that can be utilized to train the spatio-temporal VLM is illustrated. Generating instruction-following data for the spatio-temporal reasoning tasks can include grounding the kinematic quantities of objects in dynamic videos. This can further include determining trajectories, distance traveled and movement directions. Videos with substantial object movement are most suitable for these tasks, however less movement can also be used to train the VLM.

FIG. 6 depicts a top view of a car turning from a first street 610 to a second street 608 through several stages representing images at different timestamps. A car 616 has a trajectory 612 and a current direction 614. Trajectory 612 is the planned route of car 616 through state 600, state 602, state 604, and state 606. In state 600, car 616 is at the beginning of trajectory 612 and current direction is directly ahead (e.g., a “12:00 o'clock” position, 0° from north, etc.). In state 600, trajectory 612 and current direction 614 are in the same direction meaning car 616 is not turning.

In state 602, car 616 moves along trajectory 612. Current direction 614 in state 602 is different from current direction 614 in state 600 as car 616 begins to turn from street 610 to street 608 which is perpendicular to street 610. Current direction 614 in state 602 is no longer a 12:00 o'clock position but rather is a 1:00 o'clock position. In state 604, car 616 is further into the turn from street 610 to street 608. Trajectory 612 is the same but current direction 614 is at a 2:00 o'clock position. In state 606, current direction 614 is a 3:00 o'clock position which is a final direction stage of trajectory 612.

In some embodiments of the present invention, trajectory 612 can be updated, while in other embodiments of the present invention trajectory 612 can be static. Current direction 614 is the instantaneous direction the car is heading, akin to a derivative of a function representing the path taken by trajectory 612. While FIG. 6 is applicable and is described for use in autonomous driving, other uses are contemplated.

For every object (e.g. car 616) in an image representing state 600-606, a 3D center and 3D bounding box coordinates are known in a world space for each timestamp. Utilizing the 3D center coordinate

$${P}_{t}^{( i )}$$

of i-th object at t seconds, trajectories 612 are constructed by sampling the center at intervals (e.g., 0.5-second intervals) over a certain number of frames (e.g., 40-frames). The time intervals and number of frames can be changed for each use. For example, embodiments of the present invention can have 0.1-second intervals or have 100-frame videos. State 600-606 can represent first person images of the same instead of top view images or both top and side views concurrently. The 3D bounding box can be of the profile of car 616 from a front view, side view, or some combination in between.

The distance traveled of the i-th object between s and e seconds is then determined as the cumulative sum of distances between two consecutive frames (e.g., state 600 and state 602), i.e.,

$${\sum }_{t = s}^{e - 1} {‖ {P}_{t}^{( i )} - {P}_{t + 1}^{( i )} ‖}_{2}^{2} .$$

The traveling speed is also calculated by dividing the total distance traveled by the duration e-s.

Calculating the movement direction for each object is more challenging than computing distance, as an absolute direction cannot be defined across all objects in the video. A reference direction for each object is established based on the initial movement direction of the object, calculated from the first two frames in which it appears, i.e.,

$${P}_{s + 1}^{( i )} - {P}_{s}^{( i )} .$$

The reference direction can be the 12:00 o'clock position in state 600. Subsequent movement directions (e.g., current direction 614) are computed as relative angles to this reference vector as

$${θ}_{t} = ( \frac{( {P}_{t + 1}^{( i )} - {P}_{t}^{( i )} ) \cdot ( {P}_{s + 1}^{( i )} - {P}_{s}^{( i )} )}{‖ {P}_{t + 1}^{( i )} - {P}_{t}^{( i )} ‖ \times ‖ {P}_{s + 1}^{( i )} - {P}_{s}^{( i )} ‖} ) .$$

While embodiments of the present invention use positions on an analog clock to describe relative positions, other measures are also possible like radians, degrees, gradians, etc. Measures can be from the clockwise or counterclockwise directions.

States 600-606 can be processed by and use embodiments of the present invention to generate training data for improved spatio-temporal reasoning. States 600-606 can have timestamps to determine motion over a given time which aid in understanding speed. Additional information such as depth can aid in scaling objects. From this information an object's velocity, direction, distance, etc., can be derived. Using these kinematics quantities, QA pairs are formed in a large language model (LLM). The QA pairs are combined with the original video, and bounding boxes to be trained in a VLM. In other embodiments of the present invention the training data does not include QA pairs but rather, has other conversational text about the video. From this data the VLM can be trained on video as well as still images.

For example, tracking cars speed, trajectory, and direction can train an AV to identify dangerous conditions which the AV may not otherwise have much training data on. If a vehicle in front of a vehicle (e.g., car 616, an AV) is travelling straight (trajectory 612 is directly forwards, 12:00 o'clock), but current direction 614 of the vehicle is swaying left and right (e.g., fishtailing), car 616 can identify that as dangerous driving such as icy or wet conditions, or an inebriated or tired driver of the vehicle and act accordingly. Car 616 can learn to keep more distance with the vehicle that is driving poorly and itself, pull over, or act in any number of other ways.

Another example can be identifying that a vehicle is coming from a direction perpendicular of car 616 at a traffic light and is traveling too fast to safely stop at a “red light” (e.g., a “green light” for the AV car). Car 616 can begin to slow down in anticipation of/to avoid a potential collision. Car 616 can increase speed, decrease speed, turn, pull over, call for help, or perform any number of other tasks according to situations based on spatio-temporal reasoning understanding.

The spatio-temporal reasoning can aid in AV training by allowing car 616 to predict the likely outcome based on kinematic quantities when there are minimal actual examples. In other words, while there is some training data for vehicle collisions, they are limited, so collecting data to train an AV to better understand physics is a better alternative due to more availability, less costs, easier to augment the data to train on new scenarios, etc.

Computer vision techniques can also be employed like object detection, feature detection/matching, stereo vision, semantic and/or instance segmentation, keypoint detection, vision transformers, etc.

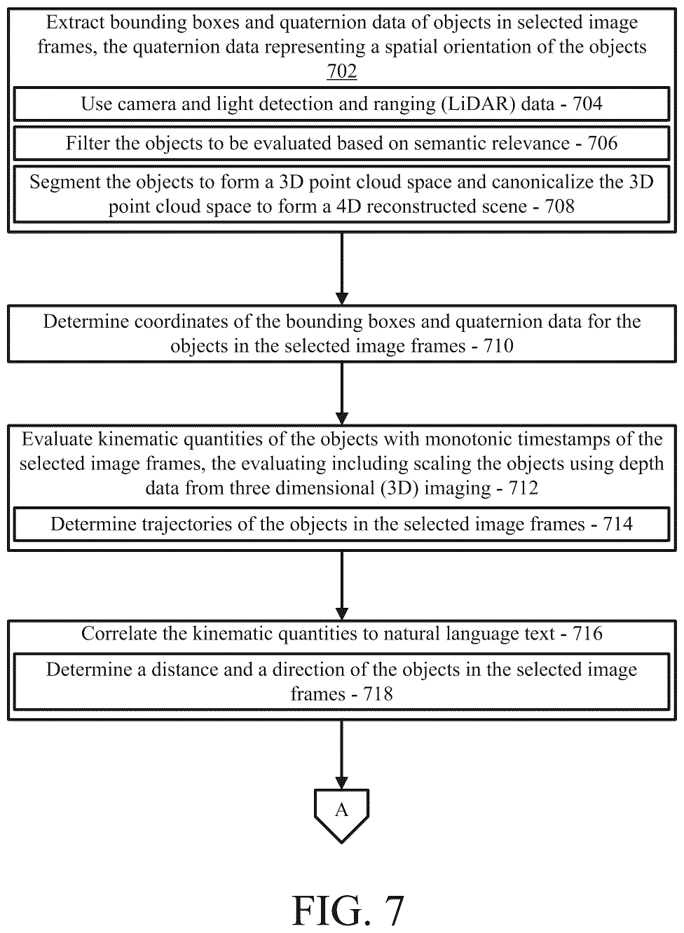

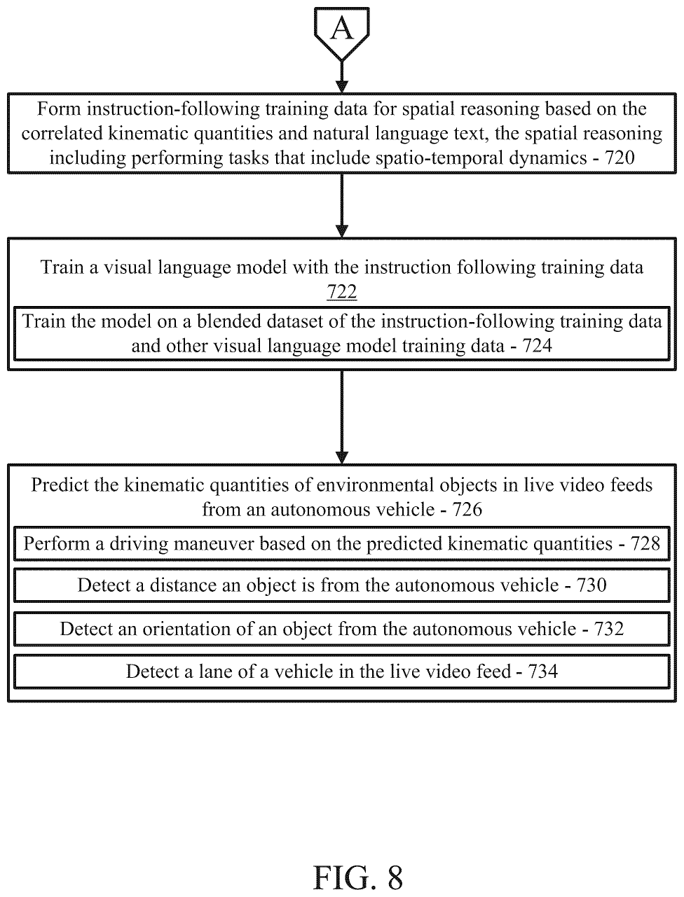

Referring to FIGS. 7 and 8, a method for instruction tuning for enhanced spatial reasoning is illustrated. In block 702, Extract bounding boxes and quaternion data of objects in selected image frames, the quaternion data representing a spatial orientation of the objects. In other words, object perimeters and orientation are identified and measured. Images can be selected from a video. The video can be of objects moving. The objects can be cars, people, animals, trees swaying, boats, etc. While embodiments of the present invention can be more robust with significant amounts of movement, any amount of movement can be used. The images can be selected to demonstrate the movement. For instance, if a car is traveling very fast, e.g., 80 miles per hour, the images can be stills from the video with timestamps taken consecutively every 0.2 seconds to demonstrate the movement to estimate kinematic quantities. There can be a set number of frames selected or until there is a sufficient quantity to determine kinematic quantities.

Kinematic quantities can be velocity, speed, acceleration, jerk, direction, relative motion, angular kinematics, trajectory, etc. Other kinematic quantities are also contemplated, and this list is not intended to be limiting.

In block 704, the bounding boxes and quaternion data are extracted through the use of camera and light detection and ranging data. In block 706, the objects to be evaluated are filtered based on semantic relevance. In other words, while objects can be detected and some even can move, they are not necessarily relevant to the training and spatio-temporal training. Irrelevant objects are filtered. For example, a discarded grocery bag can be moving within a video but since the bag can be sematantically irrelevant in some uses, bounding boxes and quaternion data relating to it can be filtered out. Filtering techniques can include bounding box size, object classification (e.g., litter can be filtered while automobiles are not), etc. This can reduce computational load, training time, improve AV training by ignoring unimportant objects, and otherwise improve AV training data generation and training.

In block 708, the objects are segmented to form a 3D point cloud space, and the 3D point cloud space is canonicalized to form a 4D reconstructed scene. Canonicalization can involve aligning the 3D point clouds from multiple frames into a global coordinate system, correcting for camera motion and scale differences. This allows the motion of each object and geometry to be represented in a unified 4D space over time. In block 710, the coordinates of the bounding box and the quaternion data are determined for the objects in the selected images frames. The metric depth of the objects in the selected image frames can also be determined. The metric depth can aid in determining scaling.

In block 712, the kinematic quantities of the objects can be evaluated. The evaluation can be for a monotonic set of the selected image frames and the evaluation can include scaling the objects using depth data from 3D imaging. The monotonic timestamps of the selected image frames can include frames that go in either monotonic ascending or descending order.

In block 714, the trajectories of the objects in the selected image are determined based off the kinematic quantities. In block 716, the kinematic quantities correlate the kinematic quantities to natural language text. In block 718, a distance and a direction of the objects in the selected image frames are determined. In block 720, instruction-following training data is formed for spatial reasoning based on the correlated kinematic quantities and natural language text, the spatial reasoning including performing tasks that include spatio-temporal dynamics. Spatio-temporal dynamics can include any tasks that include movement and tracking of objects between images.

In block 722, a visual language model is trained with the instruction-following training data. In block 724, the model is trained with a blended dataset of instruction-following training data and other visual language model training data. The blended dataset can prevent the model from committing catastrophic forgetting. In block 726, the kinematic quantities of environmental objects in live video feeds from an autonomous vehicle are predicted. In block 728, the kinematic quantities of the environmental objects can aid the autonomous vehicle to decide how to act in some circumstances. Additionally in block 728, a driving maneuver can be perform based on the predicted kinematic quantities. Driving maneuvers can include steering, braking, accelerating, communicating, using lights, using a horn, etc. In block 730, a distance of an object is detected from the autonomous vehicle.

In block 732, an orientation of an object is detected from the autonomous vehicle. In block 734, a lane of a vehicle is detected in the live video feed.

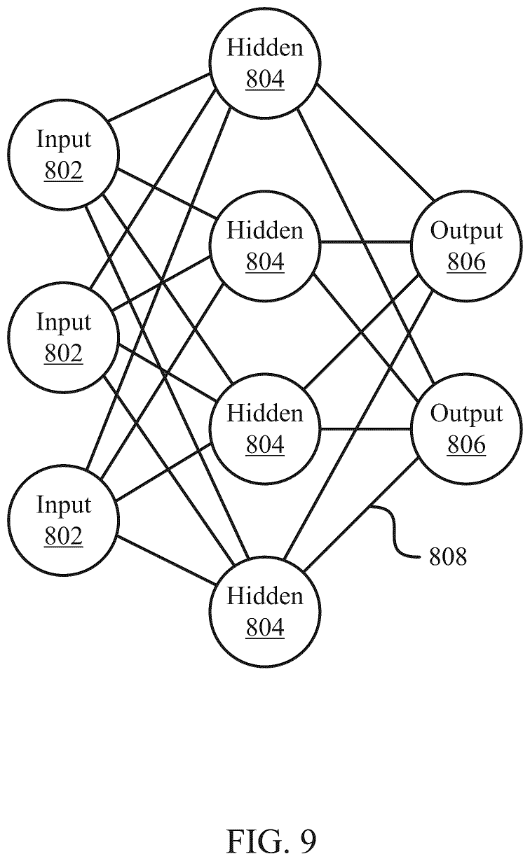

Referring now to FIG. 9, a generalized diagram of a neural network is shown. An artificial neural network (ANN) can be integrated into VLM instruction tuning for (enhanced) spatial reasoning. LLMs and VLMs are types of ANNs. LLMs process text image pairs to form the training data. VLMs understand spatio-temporal reasoning for tasks and use the training data to accurately generate and predict according to prompts reflecting the tasks. There can be several modules in the ANN that can perform the same, similar, or different tasks.

An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process. The ANN can identify patterns in text or other forms of communication and form embeddings for future processing. These patterns can relate actions and objects, relate objects to other objects, or actions to other actions. The ANN can identify seemingly unrelated or innocuous patterns or relationships with correlations. The ANN can bound objects into bounding boxes, extract objects from bounding boxes, classify actions, embed objects from features, and extract actions from text, among other capabilities.

Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 802 that provide information to one or more “hidden” neurons 804. Connections 806 between the input neurons 802 and hidden neurons 804 are weighted, and these weighted inputs are then processed by the hidden neurons 804 according to some function in the hidden neurons 804. There can be any number of layers of hidden neurons 804, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 806 accepts and processes weighted input from the hidden neurons 804.

This represents a “feed-forward” computation, where information propagates from input neurons 802 to the output neurons 806. Upon completion of a feed-forward computation, the output is compared to a desired output available from training data. The error relative to the training data is then processed in “backpropagation” computation, where the hidden neurons 804 and input neurons 802 receive information regarding the error propagating backward from the output neurons 806. Once the backward error propagation has been completed, weight updates are performed, with the weighted connections 806 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each connection 808 weight may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs.

The training data can update the weight values of hidden neurons 804 to more accurately understand spatio-temporal relationships. The updated weights can aid the model in understandings spatio-temporal changes in the model and track them to kinematic quantities.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for training a model comprising:
extracting bounding boxes and quaternion data of objects in selected image frames, the quaternion data representing a spatial orientation of the objects;
determining coordinates of the bounding boxes and the quaternion data for the objects in the selected image frames;
evaluating kinematic quantities of the objects with monotonic timestamps of the selected image frames, the evaluating including scaling the objects using depth data from three dimensional (3D) imaging;
correlating the kinematic quantities to natural language text;
forming instruction-following training data for spatial reasoning based on the correlated kinematic quantities and natural language text, the spatial reasoning including performing tasks that include spatio-temporal dynamics; and
training a visual language model with the instruction-following training data.

2. The method of claim 1, wherein extracting bounding boxes and quaternion data further includes:
using camera and light detection and ranging (LiDAR) data.

3. The method of claim 1, wherein evaluating kinematic quantities of the objects in the selected images frames further includes:
determining trajectories of the objects in the selected image frames.

4. The method of claim 1, wherein correlating the kinematic quantities to text further includes:
determining a distance and a direction of the objects in the selected image frames.

5. The method of claim 1, wherein training the visual language model further includes:
training the model on a blended dataset of the instruction-following training data and other visual language model training data.

6. A system for generating training data, comprising:
a processor; and
a memory storing computer-readable instructions that, when executed by the processor, cause the system to:
extract bounding boxes and quaternion data of objects in selected image frames, the quaternion data representing a spatial orientation of the objects;
determine coordinates of the bounding boxes and the quaternion data for the objects in the selected image frames;
evaluate kinematic quantities of the objects with monotonic timestamps of the selected image frames, the evaluation including scaling the objects using depth data from three dimensional (3D) imaging;
correlate the kinematic quantities to natural language text;
form instruction-following training data for spatial reasoning based on the correlated kinematic quantities and natural language text, the spatial reasoning including performing tasks that include spatio-temporal dynamics;
train a visual language model with the instruction-following training data; and
predict the kinematic quantities of environmental objects in live video feeds from an autonomous vehicle.

7. The system of claim 6, wherein causing the system to predict the kinematic quantities further comprises causing the system:
detect a distance an object is from the autonomous vehicle.

8. The system of claim 6, wherein causing the system to predict the kinematic quantities further comprises causing the system:
detect an orientation of an object from the autonomous vehicle.

9. The system of claim 6, wherein causing the system to predict the kinematic quantities further comprises causing the system:
detect a lane of a vehicle in the live video feed.

10. The system of claim 6, wherein the memory further causes the system to:
filter the objects to be evaluated based on semantic relevance.

11. The system of claim 6, wherein the memory further causes the system to:
segment the objects to form a 3D point cloud space and canonicalize the 3D point cloud space to form a 4D reconstructed scene.

12. The system of claim 6, wherein causing the system to train the visual language model further includes causing the system to:
blend the instruction-following training data and other visual language model training data.

13. The system of claim 6, wherein causing the system to predict the kinematic quantities further includes causing the system to:
perform a driving maneuver based on the predicted kinematic quantities.

14. A computer program product comprising a non-transitory computer-readable storage medium containing computer program code, the computer program code when executed by one or more processors causes the one or more processors to perform operations, the computer program code comprising instructions to:
extract bounding boxes and quaternion data of objects in selected image frames, the quaternion data representing a spatial orientation of the objects;
determine coordinates of the bounding boxes and the quaternion data for the objects in the selected image frames;
evaluate kinematic quantities of the objects with monotonic timestamps of the selected image frames, the evaluation including scaling the objects using depth data from three dimensional (3D) imaging;
correlate the kinematic quantities to natural language text;
form instruction-following training data for spatial reasoning based on the correlated kinematic quantities and natural language text, the spatial reasoning including performing tasks that include spatio-temporal dynamics;
train a visual language model with the instruction-following training data; and
predict the kinematic quantities of environmental objects in live video feeds from an autonomous vehicle.

15. The computer program product of claim 14, wherein causing the one or more processors to predict the kinematic quantities further comprises causing the one or more processors to:
detect a distance an object is from the autonomous vehicle.

16. The computer program product of claim 14, wherein causing the one or more processors to predict the kinematic quantities further comprises causing the one or more processors to:
detect an orientation of an object from the autonomous vehicle.

17. The computer program product of claim 14, wherein causing the one or more processors to predict the kinematic quantities further comprises causing the one or more processors to:
detect a lane of a vehicle in the live video feed.

18. The computer program product of claim 14, wherein causing the one or more processors to:
filter the objects to be evaluated based on semantic relevance.

19. The computer program product of claim 14, wherein causing the one or more processors to:
segment the objects to form a 3D point cloud space and canonicalize the 3D point cloud space to form a 4D reconstructed scene.

20. The computer program product of claim 14, wherein causing the one or more processors to train the visual language model further includes causing the one or more processors to:
blend the instruction-following training data and other visual language model training data.
